(19) United States
(12) Patent Application Publication
(10) Pub. No.: US 2004/0025183 A1
(43) Pub. Date: Feb. 5, 2004

(54) Optimization of personal television

(75) Inventor: Karl Wittig, New York, NY (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/210,836

(22) Filed: Jul. 31, 2002

(51) Int. Cl. H04N 7/16; G06F 9/44; G06F 13/10; G06F 13/12; H04N 7/173

(52) U.S. Cl. 725/90; 725/115; 725/145; 725/88

(57) ABSTRACT

A method, system and computer readable medium are provided for modeling a personal television system. A computer implemented model of a video processing chain is formed, including processing steps performed by the personal television system on a received video signal; one or more additional functions are inserted into the model, including a first function portion that represents encoding of the video signal within the personal television system before storage and a second function portion that represents decoding of stored encoded video data within the personal television system.

### FIELD OF THE INVENTION

The present invention relates to modeling and optimization techniques for televisions.

### BACKGROUND OF THE INVENTION

A number of “personal television” (PTV) systems have been introduced on the market that can receive an analog television broadcast signal, either transmitted over the air or distributed over a cable television (CATV) system, and use digital compression and storage technologies to record them for subsequent playback by the viewer. Three such systems are “TiVo™,” marketed by Philips and Sony, “Replay-TV,™” marketed by Matsushita (Panasonic), and Ultimate-TV™,” marketed by Microsoft. These systems perform the same primary function for which video-cassette recorders (VCR) have traditionally been used by viewers, namely time-shifting of broadcast programs, but offer the additional advantage of allowing the viewer to watch one program while recording a second, and free the user from keeping track of the locations of recorded programs within a linear video tape and of the locations and lengths of available tape for recording new programs. Consequently, they are becoming more popular, and, as long as analog transmission and distribution of broadcast video continues to be used, this will probably continue to be the case.

PTV systems typically receive analog radio frequency (RF) broadcast signals (although the analog output of a satellite TV decoder can also be used) and convert them to digital format after demodulation and analog video decoding (NTSC, PAL, etc.). These signals are then compressed using a lossy digital video compression scheme such as MPEG 1 or 2, and recorded on a mass-storage device such as a high-density hard disk drive (HDD). The use of compression, along with the high data capacity of modem storage devices (which keeps increasing very rapidly with time), has made possible the recording of many hours of broadcast video on an HDD, thereby eliminating the need for analog video recording tape and providing the above-described advantages of digital storage.

Video processing systems are generally called upon to improve the picture quality of sources that were transmitted either as analog broadcasts or as digital video, but not as both. In the case of analog broadcast video, the picture quality may typically be impaired by channel noise, which can include, for example, Gaussian noise whose spectrum is shaped by the transmission channel and by the demodulation and analog decoding of the video signal. Other characteristics, such as color accuracy and picture sharpness can be affected by this processing as well. In the case of digital video, noise is not present (except for small amounts introduced before digitization of the video signal), and color accuracy is not affected. The lossy compression and subsequent decoding, however, can introduce a number of video artifacts, such as block impairments, and can affect the picture sharpness as well. Such artifacts, in turn, are never present in an analog broadcast video source (except when the source was originally digital, in which case it was usually coded using a low compression ratio and therefore of high quality and with few of these impairments). Consequently, only one or the other category of image impairment traditionally appears in a received video broadcast, but not both.

In a PTV system, however, the analog broadcast signal is demodulated and decoded in the conventional manner, and can therefore have any or all of the traditional analog impairments. It is then compressed, by the highest ratio permissible, in order to use as little HDD space as possible. This introduces any or all of the above-described digital impairments to the video when it is subsequently read from the HDD and decoded, and they can be significant for the high compression ratios that are commonly used in these systems. As a result, the same video sequence will have both the analog broadcast and the digital coding impairments when seen by the viewer, and either or both may be quite significant. This is clearly different from the traditional situation.

A number of methodologies have been proposed for the optimization of image quality in a video processing system. A general methodology for automated video chain optimization is described in Van Zon, Kees and Ali, Walid, “Automated Video Chain Optimization,” International Conference on Consumer Electronics (ICCE) 2001, and Ali, Walid and van Zon, Kees, “Optimizing a Random System of Cascaded Video Processing Modules by Parallel Evolution Modeling,” International Conference on Image Processing, 2001, both of which are incorporated by reference herein in their entireties. Reference video sequences are processed using an initial video processing chain of operations. Quality is measured. Optimization techniques such as genetic algorithms are usually applied, which allow a global optimization to be performed over a large parameter search space, in conjunction with a method of determining the objective image quality (OIQ) of the resulting video. Such methods have been either applied to or proposed for analog video processing systems, which are designed to improve the image quality of analog broadcast video, or digital video systems, which are designed for digitally coded video.

In the case of analog video, such techniques as channel noise reduction (temporal and/or spatial) and peaking for sharpness enhancement (horizontal, and possibly vertical) are commonly used to improve the image quality, and video processing “chains” typically implement these and other video functions. The optimization of such a chain requires a set of parameters for all of these functions that simultaneously results in the best possible image quality for the given functions.

For digital video, some form of noise reduction is often used before the compression coding because of the well-known phenomenon of small differentials between corresponding regions of different images resulting from the noise, which must nevertheless be encoded and thereby waste limited data bandwidth. The result, in addition to preserving the noise, is equivalent to a reduction of the effective coded data rate, which is in turn equivalent to an increase in the compression ratio. The visual impairment of image quality that results directly from such low noise levels is usually a secondary consideration in these systems. Also used in some systems are methods for reducing the effects of block impairments that result, after decoding, from encoding at a high compression ratio. Discarding of high spatial frequencies, which can also occur at these high ratios, can noticeably reduce the image sharpness as well, so that some form of sharpness enhancement is desired.

An optimization method for PTV is desired.

### SUMMARY OF THE INVENTION

A method, system and computer readable medium for modeling a personal television system are provided. A computer implemented model of a video processing chain is formed, including processing steps performed by the personal television system on a received video signal; one or more additional functions are inserted into the model, including a first function portion that represents encoding of the video signal within the personal television system before storage and a second function portion that represents decoding of stored encoded video data within the personal television system.

### BRIEF DESCRIPTION OF THE DRAWINGS

FIG. 1 is a block diagram of a system for optimizing the video processing chain of a personal television.

FIG. 2 is a flow chart of a process for optimizing the video processing chain of a personal television.

### OVERVIEW

A complete PTV system having the capability of encoding, storing, reading, decoding, and processing digital video can be optimized using techniques based on those mentioned above for analog video systems, by treating the first four elements (encoding, storing, reading, and decoding in the PTV) as part of the video processing chain. In particular, encoding is typically performed with the desired data rate (or compression ratio) as the primary (and optionally, the only) system parameter, whereas decoding is strictly a function of the retrieved video data stream, and therefore has no parameters that can be adjusted.

Finally, if a data-flow representation of the video data is used in the optimization methodology, as is more commonly becoming the case, the writing and reading of the storage medium simply constitutes a time delay of the video data stream, and can therefore be completely ignored. MPEG, encoding and decoding are digital processing algorithms that can be modeled as such within the context of this optimization, but, on top of that, when storing the data in a hard disk and then reading the data out, because the methodologies are data driven, there is no concept of time. Thus, writing data followed by subsequent reading is nothing more than a time delay. Since the encoding, storage, reading, and decoding are always performed in direct succession, these four elements of a digital processing system can be treated as a single function.

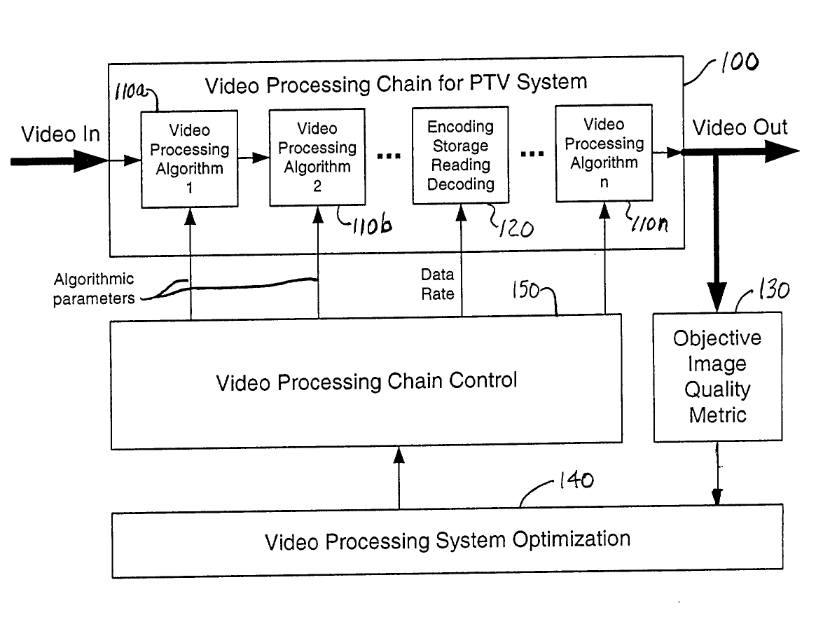

Furthermore, in a relatively simple model of the encoding, storage, reading and decoding operations of the PTV, a single parameter can be varied during the optimization process and provide effective optimization. An example of such a single parameter is the compression ratio. The data rate may be used as a substitute for the compression ratio, because there is a one-to-one correspondence between the compression ratio and the data rate. Alternatively, more complex models of the encoding, storage, reading and decoding operations of the PTV may be used, with two or more parameters varied during the optimization process. FIG. 1 is a block diagram showing a system for the optimization of a PTV system.

A PTV system can be modeled using a combination of the respective functions described above for each type of system (i.e., analog and digital). In a PTV system, however, the noise reduction serves the two functions of reducing analog channel noise and improving digital coding efficiency. Also, the sharpness enhancement needs to counteract the effects of both analog frequency distortion by the channel, demodulation, and decoding, and the discarding of high-frequency information by the digital compression.

The proper optimization of such a system entails more than simply combining the individual optimizations of the analog and digital systems. Because the functions performed in the video processing chain are non-linear, the order in which functions are performed in the model should reflect the order in which the functions are performed in the real video processing chain, and the order of the processing operations (in addition to their algorithmic parameters and data bit precisions) can be optimized. The PTV system can be modeled by adding as few as one additional component over that of a conventional video processing chain, namely that of the encoding, storage, reading, and decoding functions. This component in turn has as few as one parameter, namely the compression ratio. The modeling methods that have been proposed and used for conventional video processing chains can therefore be modified to model a PTV system without a significant increase in the complexity of the optimization. Such a methodology can thus be used to optimize the overall picture quality of a type of video processing system that appears to be of increasing commercial significance.

### DETAILED DESCRIPTION

Referring to FIG. 1, an exemplary optimization system is shown. The system includes a video processing chain simulator 100. Simulator 100 is data driven as opposed to an event driven simulation. The simulator 100 performs substantially the same digital signal processing operations on the input reference video that are performed by the actual video processing system in the PTV, except that the simulator 100 does not have to perform these operations in real time.

The data input to video processing chain simulator 100 are in digital format. If the PTV receives an analog transmission signal, then the video input data represent the analog transmission signal after demodulation into the base band video signal and digitization have been performed. During an optimization, the same video sequence is used as an input throughout the iterative modeling and optimization process.

Video processing chain simulator 100 includes a plurality of video processing algorithms 110a-110n. For example, algorithm 1 (block 110a) may be noise reduction; algorithm 2 (block 110b) may be sharpness enhancement and so on, until algorithm N (block 110n), which may be removal of MPEG blocking effects. The selection of the algorithms is driven by the algorithms that are used in the PTV system to be modeled.

At least one additional function 120 is added to represent the processing performed during the encoding, storage, reading, and decoding functions. The encoding portion of this function 120 should model the actual encoding hardware to be used in the PTV system being optimized. In practice, an MPEG encoder chip would be used. That chip would use a specific encoding algorithm, so a software model of the algorithm that is implemented by the chip is used. With MPEG encoders, there are different models because an MPEG goal is to get as good a compression as possible, meaning obtaining as good a picture fidelity as possible. This entails getting as many pixels through effectively as possible, or getting as much pixel information through as possible using the minimum number of coded bits. For any video sequence there is a large number of possible legal encodings. Thus, the encoder model should be one that models the actual hardware to be used in the system.

The decoder portion of function 120 can be directly implemented from the MPEG 1 standard (ISO/IEC 11172-1 (through -5):1993) or the MPEG II standard (ISO/IEC 13818-4:1998/Amd 2:2000), which are incorporated herein by reference. Various portions of the MPEG standards are defined as segments or blocks of C-code, so one of ordinary skill can readily adopt the decoder C-code to model an MPEG decoder.

As noted above, the storage and retrieval operations only represent delays, which are not modeled in the simulation. Neither operation transforms the data or affects image quality.

The decoded output data from the video processing chain simulator 100 are provided to an objective image quality metric block 130. Objective image quality metrics are typically selected and adjusted to provide good correlation between a quality measure given by the objective metrics and subjective image assessments by a panel of viewers of images or video sequences using a predetermined set of images or video sequences. The objective image quality metric may, for example, provide a measure of image quality that takes into account analog noise, blocking, ringing, mosquito artifacts and other types of artifacts. The metric may also apply respectively different weights to the effect each of the aforementioned factors has on image quality; adjusting the weights can improve the correlation between the measure provided by the objective metric and the subjective assessments.

For optimization purposes, the algorithmic parameters, process orderings, and data bit precisions, and the resulting objective image metric values are the pertinent data. The actual video output data are not required to be stored for optimization purposes.

Block 140 is a video processing system optimization block. Desirable attributes of the optimization block 140 include accuracy and speed. Because there is a huge number of different combinations of parameter values and ordering of processes, it is not practical to run ever single combination to find the global optimum. On the other hand, algorithms (e.g., Newton's method) that are likely to converge on a local maximum or minimum when there is a larger global maximum or smaller global minimum should not be used either.

Genetic algorithms are a preferred approach for video processing chain optimization block 130. Genetic algorithms use an iterative, non-determinative approach based on the theory of evolution, that can evolve toward a global optimum without a priori knowledge about the search space. The genetic algorithm produces a set of candidate solutions called “chromosomes” each of which in turn consists of a plurality of “genes.” Each gene corresponds to a particular algorithmic parameter value (or subset of the algorithmic parameter values), process ordering or data bit precision.

For each chromosome in one generation, the video chain is configured, meaning all the blocks in a given desired order, a given data bit precision value set, and a given set of algorithmic parameter values are selected; the simulation 100 is run; and the objective image quality metric 130 number (“fitness value”) is provided to the genetic algorithm. Based on the values of the image quality metrics 130, a subset of the chromosomes having the best quality metric values are selected to be combined by “crossover” to form the next generation. In crossover, a subset of the algorithmic parameter values, parameter orderings and data bit precisions (i.e., a subset of the genes) are exchanged between chromosomes. Then a “mutation” is introduced by perturbing some of the genes with some (usually low) user defined probability. Mutation ensures that no portion of the search space has a zero probability of being searched, thus reducing the likelihood of converging on a local minimum or maximum, when a better global optimum solution exists. The entire set of next-generation chromosomes is ready to be processed and evaluated.

Once the values to be used for the next generation are selected, the video processing chain control block 150 sets the parameter values for each of the video processing algorithms 110a-110n and for the encoding, storage, reading and decoding function 120, as well as the process ordering and data bit precisions. The video processing chain simulator 100 can then be rerun for each of the next generation of chromosomes, using the same set of input video data.

A termination criterion for the iteration may be based on reaching an acceptable approximate solution or a stable solution, iterating through a predetermined number of mutations, iterating through a predetermined number of generations, or the like.

The genetic algorithms are attractive because they require evaluation of only a relatively small portion of the total search space (resulting in rapid convergence), yet can provide accurate results. Nevertheless, other optimization algorithms may be used by those skilled in the art for the video processing system optimization block 140.

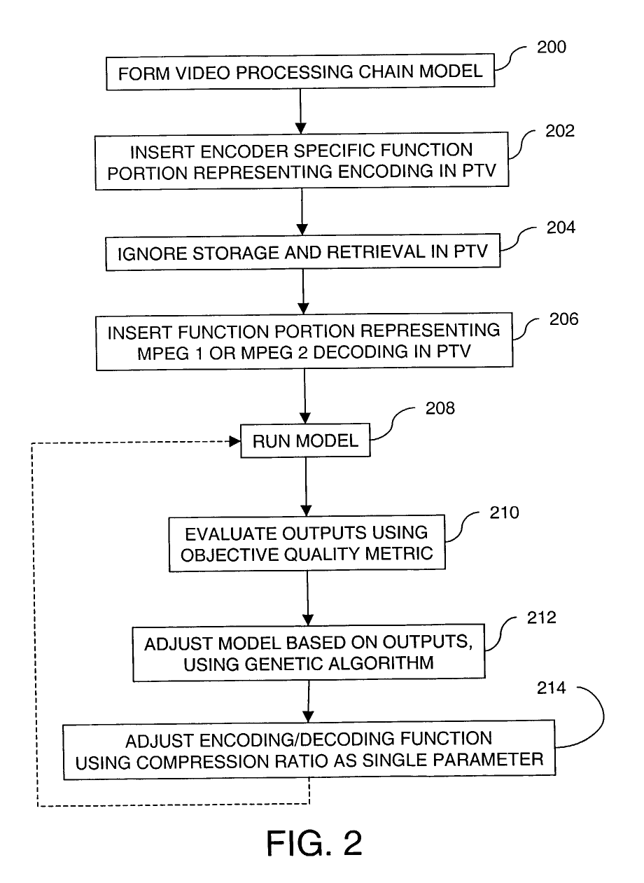

FIG. 2 shows a method for modeling a personal television system.

At step 200, a computer implemented model 100 of a video processing chain is formed, including processing steps 110a-110n performed by the personal television system on a received video signal. The model allows adjustment of the algorithmic parameters, process ordering and data bit precisions.

At step 202, an encoder specific function portion that represents encoding of the video signal within the personal television system before storage is inserted into the video processing chain model 100.

At step 204, the simulation can ignore the storage and retrieval, because neither of these operations is considered to transform the image data or affect image quality.

At step 206, a function portion representing MPEG 1 or MPEG 2 decoding of the stored data in the PTV is inserted into the video processing chain model 100. In some embodiments, steps 202 and 206 are combined so as to form a single function representing the encoding and decoding, and the storage and reading are ignored.

Steps 208-214 provide the iterative optimization. At step 208, the video processing chain model 100 is run.

At step 210, the results of the simulation are evaluated against objective image quality metric(s).

At step 212, the model is adjusted in accordance with an optimization algorithm, which may be for example, a genetic algorithm. This may include, at step 214, adjusting the encoding/decoding function using the compression ratio (or data rate) as an adjustment parameter, and may including using the compression ratio (or data rate) as the only adjustment parameter.

Steps 208-214 are repeated, until the termination criterion is met.

The present invention may be embodied in the form of computer-implemented processes and apparatus for practicing those processes. The present invention may also be embodied in the form of computer program code embodied in tangible media, such as random access memory (RAM), floppy diskettes, read only memories (ROMs), CD-ROMs, DVD-ROMs, hard drives, high density (e.g., “ZIP™” or “JAZZ™”) removable disks, or any other computer-readable storage medium, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over the electrical wiring or cabling, through fiber optics, or via electromagnetic radiation, wherein, when the computer program code is loaded into and executed by a computer, the computer becomes an apparatus for practicing the invention. When implemented on a general-purpose processor, the computer program code segments configure the processor to create specific logic circuits.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claimed is:

1. A method for modeling a personal television system, comprising the steps of:
(a) forming a computer implemented model of a video processing chain including processing steps performed by the personal television system on a received video signal; and
(b) inserting into the model one or more additional functions including a first function portion that represents encoding of the video signal within the personal television system before storage and a second function portion that represents decoding of stored encoded video data within the personal television system.

2. The method of claim 1, wherein the first function portion includes an encoder-specific model corresponding to a given encoder that is included in the personal television system.

3. The method of claim 2, wherein the second function portion includes an MPEG 1 decoder model or an MPEG 2 decoder model.

4. The method of claim 1, wherein the first function portion and the second function portion are included in a single function.

5. The method of claim 4, wherein the model ignores storage and retrieval of the encoded video signal within the personal television system.

6. The method of claim 4, wherein a compression ratio of the stored encoded video signal is used as a parameter for adjusting the single function.

7. The method of claim 1, further comprising:
(c) running the computer implemented model after step (b); and
(d) adjusting the model of the video processing chain based on outputs generated by step (c).

8. The method of claim 7, wherein step (d) includes using a genetic algorithm to select the adjustment.

9. The method of claim 7, further comprising evaluating outputs generated by step (c) using an objective image quality metric.

10. A computer readable medium having computer program code encoded thereon, wherein, when the computer program code is executed by a processor, the processor executes a method for modeling a video processing chain in a personal television, the method comprising the steps of:
(a) forming a computer implemented model of a video processing chain including processing steps performed by the personal television system on a received video signal; and
(b) inserting into the model one or more additional functions including a first function portion that represents encoding of the video signal within the personal television system before storage and a second function portion that represents decoding of stored encoded video data within the personal television system.

11. The computer readable medium of claim 10, wherein the first function portion includes an encoder-specific model corresponding to a given encoder that is included in the personal television system.

12. The computer readable medium of claim 11, wherein the second function portion includes an MPEG 1 decoder model or an MPEG 2 decoder model.

13. The computer readable medium of claim 10, wherein the first function portion and the second function portion are included in a single function.

14. The computer readable medium of claim 13, wherein the model ignores storage and retrieval of the encoded video signal within the personal television system.

15. The computer readable medium of claim 13, wherein a compression ratio of the stored encoded video signal is used as a parameter for adjusting the single function.

16. The computer readable medium of claim 10, further comprising:
(c) running the computer implemented model after step (b); and
(d) adjusting the model of the video processing chain based on outputs generated by step (c).

17. The computer readable medium of claim 16, wherein step (d) includes using a genetic algorithm to select the adjustment.

18. The computer readable medium of claim 16, further comprising evaluating outputs generated by step (c) using an objective image quality metric.

19. A system for modeling a personal television system, comprising:
a computer having programmed therein a model of a video processing chain including processing steps performed by the personal television system on a received video signal,
the computer including in the model one or more additional functions including a first function portion that represents encoding of the video signal within the personal television system before storage and a second function portion that represents decoding of stored encoded video data within the personal television system.

20. The system of claim 19, wherein the first function portion includes an encoder-specific model corresponding to a given encoder that is included in the personal television system.

21. The system of claim 20, wherein the second function portion includes an MPEG 1 decoder model or an MPEG 2 decoder model.

22. The system of claim 19, wherein the first function portion and the second function portion are included in a single function.

23. The system of claim 22, wherein the model ignores storage and retrieval of the encoded video signal within the personal television system.

24. The system of claim 22, wherein a compression ratio of the stored encoded video signal is used as a parameter for adjusting the single function.

25. The system of claim 19, further comprising:
automatic means for adjusting the model of the video processing chain based on outputs generated by running the model.

26. The system of claim 25, wherein the automatic means uses a genetic algorithm to select the adjustment.

27. The system of claim 25, further comprising means for evaluating outputs generated by running the model using an objective image quality metric.
